(19) United States
(12) Patent Application Publication
(10) Pub. No.: US 2007/0257577 A1
(43) Pub. Date: Nov. 8, 2007

(54) Electric Machine and Slip Ring Element for an Electric Machine

(76) Inventor: Franc Bizjak, Idrija (SI)

Correspondence Address: KATTEN MUCHIN ROSENMAN LLP, 575 MADISON AVENUE, NEW YORK, NY, 10022-2585, US

(21) Appl. No.: 11/628,896

(22) PCT Filed: Jun. 14, 2005
(86) PCT No.: PCT/EP05/06335

§ 371 Date: Dec. 7, 2006

(30) Foreign Application Priority Data
Jun. 16, 2004 (DE) 10 2004 028 781.3

(51) Int. Cl. H01R 39/14

(52) U.S. Cl. 310/232

(57) ABSTRACT

Disclosed is an electric machine comprising a stator (1, 1′) and a rotor (2) which is mounted in two bearing (3, 3′) so as to be rotatable about the longitudinal axis (4, 4′) thereof and is provided with a rotor winding (5, 5′). A slip ring element (7, 7′) encompassing two slip rings (10, 10′; 11, 11′) and a support member (8, 8′) that is made of insulating material and is provided with a rotor shaft pin bore (9, 9′) is disposed on a rotor shaft pin (6, 6′) which protrudes from one of the bearings (3, 3′). Said slip rings are provided with connections (12, 12′; 13, 13′) which protrude from the support member of the slip ring on the face of the slip ring element located near the bearing while being joined to the rotor winding (5, 5′). A prefabricated, graded spacing ring (21, 21′) which bridges the axial gap (22, 22′) between two adjacent slip rings and extends at least in part into the radial gap (23, 23′) between one slip ring (10, 10′) and the connection (13, 13′) of the other slip ring (11, 11′) is embedded into the support member.

The present invention relates to an electric machine with a stator and a rotor, which is mounted in two bearings to rotate around its longitudinal axis and is provided with a rotor winding, wherein there is disposed on a rotor shaft journal protruding beyond one of the bearings a slip ring element, which comprises a support member, made of insulating material and having a bore for the rotor shaft journal, and two slip rings, which are provided with leads jutting out of the support member of the slip ring element at the end face thereof proximal to the bearing and are connected to the rotor winding. Furthermore, the present invention relates to a slip ring element for an electric machine.

Such an electric machine, as has long been known in various embodiments, can be, for example, the generator of a motor vehicle. In this case, the current induced in the rotor winding is fed via the slip ring element into the electric system of the motor vehicle.

In a first type of known electric machine, in which the slip ring element is mounted on a rotor shaft journal protruding beyond one of the bearings of the rotor shaft, end portions of the rotor winding are routed through bores passing axially through the support member of the slip ring element, and at the end face of the slip ring element distal to the bearing are connected electrically conductively to the slip-ring leads jutting out of the support member there (see U.S. Pat. No. 6,437,475 B1). This permits establishment of the electrical connection between the ends of the rotor winding and the leads of the slip rings to the freely accessible end face of the slip ring element. This is true regardless of whether the two slip rings initially form a common component and are electrically separated, especially by groove turning, only after injection molding of the support member, or of whether they are two separate components to begin with. The configuration and arrangement of the slip ring element known from U.S. Pat. No. 6,437,475 B1 proves to be favorable inasmuch as the slip ring element merely has to be mounted to complete the manufacture of the otherwise prefabricated electric machine and inasmuch as it can also be replaced with only minimum time and effort. Nevertheless, this known slip ring element suffers from the disadvantage that the slip rings—because of the through bores passing through the support member for the rotor winding—frequently have undesirably large radial outside dimensions. Furthermore, installation is time-consuming and susceptible to problems during threading of the end portions of the rotor winding through the said axial through bores.

In a second type of known electric machine, which corresponds to the prior art of the class in question indicated hereinabove, there are molded onto the support member of the slip ring element, at its end face proximal to the rotor bearing, insulating ribs, which are routed through corresponding grooves of the rotor shaft below the adjacent rotor shaft bearing and in which there run the leads of the slip ring or associated lead extensions. In order to stiffen the structure, the insulating ribs are typically joined to one another at their ends distal to the slip ring element, by means of an insulating ring injection-molded in one piece with the support member of the slip ring element and the insulating ribs.

These leads or lead extensions frequently end in the region of the insulating ring, where a connection is made to the rotor winding. In this prior art, as documented in U.S. Pat. No. 5,459,364 A, U.S. Pat. No. 5,486,732 A, U.S. Pat. No. 5,521,450 A and EP 1337013 A3, for example, the limited short-circuit safety of the correspondingly equipped electric machines is a disadvantage; thus, during manufacture of this slip ring element, the lead of the second slip ring routed through below the first slip ring can, under the effect of the viscous molding compound, which is injected at high velocity into the mold, become deformed during injection molding of the slip ring element and the insulating ribs molded onto it, and thus can become dangerously close to the first slip ring or can even make contact therewith.

Furthermore, various slip ring elements have become known in connection with their arrangement inside the adjacent rotor bearing (see U.S. Pat. No. 4,645,962 A and U.S. Pat. No. 4,684,179 A). According to U.S. Pat. No. 4,684,179 A, a spacer element that is made of insulating material and that maintains the axial separation of two prefabricated slip rings during molding of the support member is embedded in the support member of the slip ring element. This spacer element simultaneously represents an assembly aid, in that the two slip rings are pushed onto bushing-like shoulders and the unit formed in this way is loaded into an injection-molding die for manufacture of the support member. During manufacture of the support member with molding compound for the support member, the radial gap between the one slip ring and the lead of the other slip ring routed radially inside it is filled out to form an insulating portion there. For this purpose, the spacer element is provided with a slot-like aperture extending over its axial length, or it is incised at least in the region of the radial gap between the one slip ring and the lead of the other slip ring. A disadvantage in this known slip ring element is once again the limited short-circuit safety.

In view of the prior art outlined in the foregoing, the object of the present invention is to provide, for an electric machine, a slip ring element that can be inexpensively manufactured and that is particularly safe against short circuits despite small radial outer dimensions of the slip rings, and also to provide an electric machine with such a slip ring element. For this purpose it would be particularly desirable, in the case that the rotor winding is connected to the leads of the slip ring element outside the adjacent rotor bearing, at the same time to facilitate mounting of the slip ring element on the prefabricated rotor and contacting of the slip rings with the rotor winding.

According to the present invention, this object is achieved for an electric machine of the class in question by the fact that there is embedded, in the support member of the slip ring element, a prefabricated spacer ring of stepped structure, which bridges over the axial gap between each pair of mutually adjacent slip rings and extends at least partly into the radial gap between the one slip ring and the lead of the other slip ring. The slip ring element employed in inventive electric machines can be manufactured by using prefabricated slip rings, which are separate to begin with and which are pushed from both sides onto the spacer ring, before the corresponding unit comprising the two slip rings and the spacer ring is inserted into an injection-molding die, in which the support member of the slip ring element and if necessary the insulating ribs molded onto it are injection molded. Subsequent machining of a blank for the slip ring element, especially by groove turning, is therefore not necessary in this case. This is advantageous for inexpensive manufacture of the slip ring element. Because the spacer ring of the slip ring element has stepped structure and extends at least partly into the radial gap between the one slip ring and the lead of the other slip ring, good fixation of the lead of the second slip ring is achieved, and so this lead cannot be radially deformed outward during injection molding of the support member, to the point that a short circuit or dangerous proximity to the adjacent slip ring occurs. Compared with the prior art according to U.S. Pat. No. 4,684,179 A, therefore, the short-circuit safety is increased by application of the present invention, because the spacer ring extends at least partly into the radial gap between the one slip ring and the lead of the other slip ring, and in this way contact and even inadmissible proximity between the two said parts is effectively prevented, in particular during injection molding of the support member, during which the molding compound is injected at high velocity into the mold.

Particularly preferably, the spacer ring is composed of the same material as the rest of the support member of the slip ring element; this is favorable in view of good bonding of the spacer ring to the injection-molded support member and thus of high reliability and long useful life. However, this is not an imperative requirement. To the contrary, the spacer ring may also be composed of any other suitable insulating material.

According to another preferred improvement of the invention, the spacer ring is provided with a middle part and two bushing-like shoulders of reduced diameter, the two slip rings associated with the spacer ring resting on the outside of the bushing-like shoulders. In this case it is particularly favorable for the particular bushing-like shoulder that extends at least partly into the radial gap between the one slip ring and the lead of the other slip ring to be provided with an axial extension in the region of the lead in question. Hereby there is achieved an optimal effect of the spacer ring as regards short-circuit safety, without detracting from the permanent bonding of the slip ring to the support member. The axial extension in question is preferably to be dimensioned such that the radial gap between the one slip ring and the lead of the other slip ring is filled with the spacer ring to a proportion of at least 60% and better still of at least 70% of the axial height of the slip ring.

Another preferred improvement of the invention is characterized in that the particular bushing-like shoulder that does not extend into the radial gap between the one slip ring and the lead of the other slip ring is provided with an opening for the lead of the slip ring associated with this shoulder. Particularly preferably, each opening is adjoined by a pocket disposed on the radial inside of the spacer ring, in order to receive the lead of the other slip ring routed radially through below the one slip ring. Such a pocket enhances the bracing and fixation of the lead in question in both radial and circumferential direction during injection molding of the support member.

According to yet another preferred improvement of the invention, it is provided that, in a slip ring unit equipped with two slip rings, the spacer ring is of axially symmetric construction. In this case, the extensions, openings and pockets explained hereinabove, if provided at all, are present in pairs, specifically being disposed diametrically opposite one another. This simplifies the joining of the spacer ring and the two slip rings together as a pre-assembled unit, so that this step is immediately automated and thus can be completed particularly inexpensively.

The present invention is particularly suitable for applications in which the rotor winding is routed through below the rotor bearing adjacent to the slip ring element and is connected outside the rotor bearing in question to leads—which jut out from the support member at the end face of the slip ring element proximal to the bearing—of the slip ring element. Preferably the support member of the slip ring element is then provided at its end face proximal to the bearing, in the region of the leads, with depressions that receive the outermost ends of the rotor winding. Such depressions, which can be provided in the radially outer zone, directly adjacent to the leads of the slip rings, support positioning of the ends of the rotor winding in correct orientation during mounting of the slip ring element; in this way they facilitate mounting of the slip ring element and contribute to a particularly reliable electrical connection of the leads of the slip rings to the rotor winding.

According to another preferred improvement of the embodiment of the invention explained hereinabove, end regions of the rotor winding that have been stripped of insulation are mechanically clamped in the leads of the slip rings. For this purpose, the leads of the slip rings are preferably made V-shaped to begin with at their ends, and particularly preferably these V-shaped ends of the leads of the slip rings are then radially open outward. After the conductors bared by stripping of the insulation of the end portions of the rotor winding have been laid in the V-shaped ends of the leads, these ends are squeezed together to establish intimate contact with the conductor of the rotor winding on both sides. This squeezing together can be accomplished by means of electrodes, so that the mechanical deformation of the ends of the leads is simultaneously accompanied by fusion of the conductors of the rotor winding with the leads by resistance welding. This is also favorable in particular with a view to simple mounting of the slip ring element and to establishment of a reliable electrical connection between the rotor winding and the slip rings. Other suitable methods of connecting the conductors of the rotor winding to the leads of the slip rings include brazing or laser welding.

However, the present invention is not limited to such applications in which the rotor winding is routed through below the rotor bearing adjacent to the slip ring element. The special advantages of the invention explained hereinabove are also obtained specifically when there are molded, onto the support member of the slip ring element, insulating ribs, which are routed through below the adjacent rotor bearing and in which the leads or associated lead extensions jutting out of the support member of the slip ring element are received. Such a configuration, in which the rotor winding is connected to the leads of the slip ring element or to associated lead extensions inside the rotor bearing in question, has the advantage that the connections of the rotor winding to the leads of the slip ring element can be made close to the coil of the rotor winding and substantially on the diameter thereof.

In this case it is particularly advantageous if lead extensions received in the insulating ribs are connected in one piece to the lead portions manufactured together with the slip rings at points distal to the slip rings. The lead extensions as well as the slip rings with the lead portions molded onto them are expediently made of copper and are cut out of a corresponding sheet. The connection of the lead extensions to the associated lead portions is then preferably established via one ultrasonic weld each. Because the corresponding connection points are disposed well away from the slip rings, the hardness of these rings is not negatively affected by the heat generated during the welding operation.

It is precisely in those embodiments explained hereinabove in which the rotor winding is not routed through below the rotor bearing adjacent to the slip ring element that the fixation and bracing of each lead routed through below the other slip ring proves to be particularly advantageous because of the spacer ring extending into the corresponding radial gap. After all, because of this effective bracing, even a long lead or a long lead extension needs to be braced only at its end—which in any case is bare—in the mold used for injection-molding of the support member. No additional bracing is needed between this end and the connection of the lead in question to the associated slip ring. Consequently, with the exception of their ends, leads or lead extensions can be completely surrounded during injection molding with the same molding compound from which the support member of the slip ring element and the insulating ribs molded onto it are manufactured. This reduces the problem that exists in known slip ring elements having similar design and that causes voltage breakdowns and creepage currents during generator operation in the region of additional bracings of the lead extensions.

Although the present invention has been explained in the foregoing on the basis of slip ring elements having (only) two slip rings, no limitation in this respect is to be construed. To the contrary, the present invention similarly encompasses electric machines whose slip ring elements are equipped with more than two slip rings. In all other respects, the advantages of the present invention explained in the foregoing can obviously be exploited in the same way even for such electric machines in which the slip ring element is disposed inside the two rotor bearings.

The present invention will be explained in more detail hereinafter on the basis of two preferred practical examples illustrated in the drawing, wherein

FIG. 1 shows an axial section through the end portion of the rotor of a first embodiment of an electric machine according to the invention, wherein the connection of the rotor winding to the slip rings has not yet been established in final form,

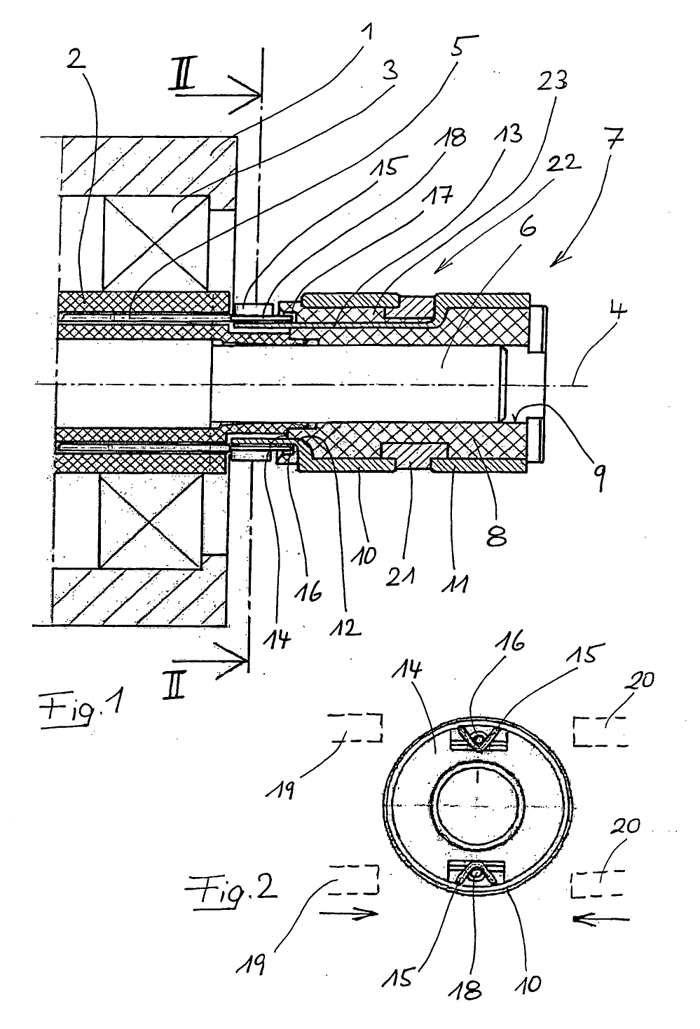

FIG. 2 shows a radial section along line II-II of FIG. 1,

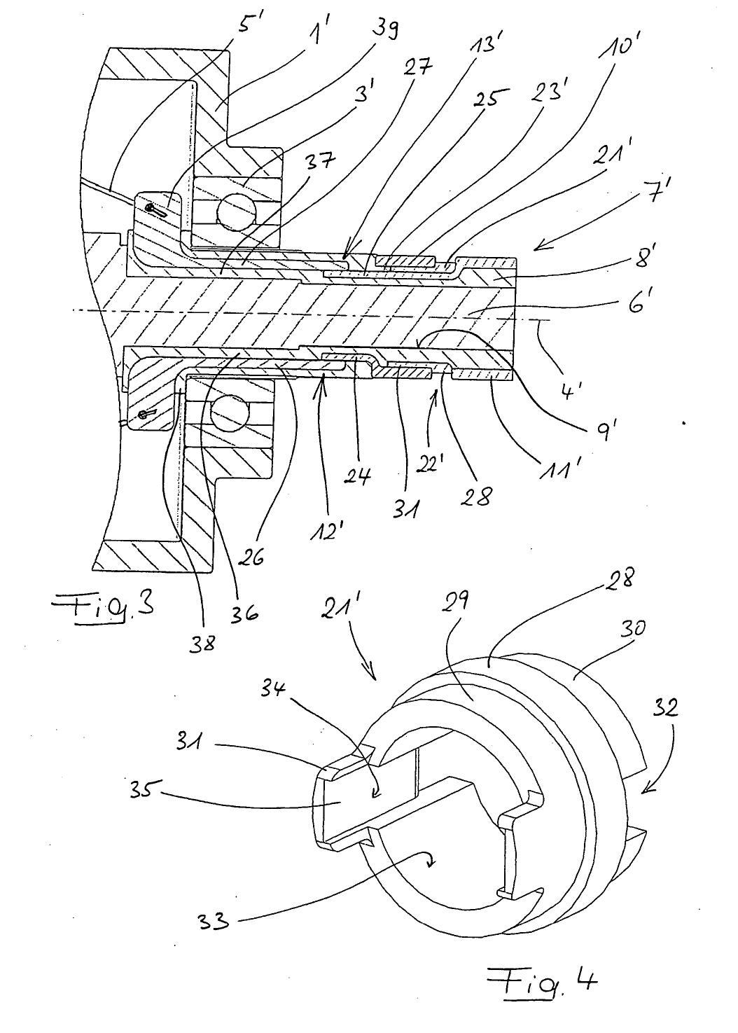

FIG. 3 shows an axial section through the end portion of the rotor of a second embodiment of an electric machine according to the invention, and

FIG. 4 shows a perspective, enlarged view of the spacer ring used to manufacture the slip ring element according to FIG. 3.

The electric machine, only the region of interest of which is illustrated here in FIGS. 1 and 2, comprises a stator 1 and a rotor 2. Rotor 2 is mounted in two bearings 3 to rotate around its longitudinal axis 4. It is provided with a rotor winding 5.

A slip ring element 7 is disposed on a rotor shaft journal 6 protruding beyond bearings 3. This element comprises a support member 8, made of insulating material and having a bore 9 for the rotor shaft journal, and two slip rings, namely a slip ring 10 proximal to the bearing and a slip ring 11 distal to the bearing. Slip rings 10 and 11 are provided with leads 12 and 13 respectively, each of which is branched off from the inside of the ring proper and is connected to rotor winding 5.

Leads 12 and 13 molded onto the slip rings are routed through support member 8 to end face 14 of slip ring element 7 proximal to the bearing, and they jut out of end face 14 of the slip ring element proximal to the bearing. In the illustrated stage of manufacture, ends 15 of leads 12 and 13 are V-shaped, and the Vs are open radially outward.

On its end face 14 proximal to the bearing, in the radially outer zone thereof, support member 8 of slip ring element 7 is provided adjacent to leads 12 and 13 with two depressions 16, which receive the outermost ends 17 of insulation-stripped conductors 18 of rotor winding 5. Furthermore, bare conductors 18 of the rotor winding rest at the bottoms of V-shaped ends 15 of associated leads 12 and 13 respectively. When ends 15 of leads 12 and 13 are squeezed together, each by means of two electrodes 19 and 20 disposed opposite one another, those ends 15 become mechanically deformed, thus are mechanically clamping conductors 18 together with the leads, while the conductors become fused with the leads by resistance welding.

In support member 8 there is embedded a prefabricated spacer ring 21, which bridges over axial gap 22 between the two slip rings 10 and 11. Spacer ring 21 has stepped structure, so that it bears not only at its end faces on the two slip rings 10 and 11, but also partly on the radial inner circumferential surfaces thereof. In particular, therefore, spacer ring 21 also extends partly into radial gap 23 between slip ring 10 proximal to the bearing and lead 13 of slip ring 11 distal to the bearing.

In the embodiment according to FIGS. 3 and 4, leads 12′ and 13′ of slip ring element 7′ disposed on rotor shaft journal 6′ respectively embrace lead portions 24 and 25 manufactured in one piece with associated slip rings 10′ and 11′ and lead extensions 26 and 27 welded thereto at a distance from the slip rings. Lead extensions 26 and 27 are routed through below rotor bearing 3′, so that rotor winding 5′ is connected to leads 12′ and 13′ of slip ring element 7′ inside rotor bearing 3′ in question. On support member 8′ of slip ring element 7′, there are molded onto its end face on the bearing side two insulating ribs 36 and 37, which are routed through in axial grooves of the rotor shaft below the inner ring of rotor bearing 3′, and in which lead extensions 26 and 27 are received. At their ends, insulating ribs 36 and 37 are joined to one another via an insulating ring 38 injection-molded in one piece with support member 8′ of slip ring element 7′ and the insulating ribs. Lead extensions 26 and 27 end in the region of insulating ring 38 with uncovered terminal lugs 39, at which a connection is made to rotor winding 5′.

Between their terminal lugs 39 and the transition of the associated lead portion into the slip ring in question, leads 12′ and 13′ are completely embedded in that molding compound from which support member 8′ and insulating ribs 36 and 37 are injection molded.

Spacer ring 21′ illustrated in detail in FIG. 4 is provided with a middle part 28 and two bushing-like shoulders 29 and 30 of reduced diameter. Each of the two slip rings 10′ and 11′ bears externally on one of the bushing-like shoulders. Bushing-like shoulder 29, which extends into radial gap 23′ between slip ring 10′ shown on the left and lead portion 25 of slip ring 11′ shown on the right, is provided in the region of lead portion 25 in question and in the region diametrically opposite thereto with an axial extension 31. Axial extension 31 is dimensioned such that radial gap 23′ between slip ring 10′ and lead portion 25 is filled to approximately 75% of the axial height of slip ring 10′ with spacer ring 21′.

Oppositely disposed bushing-like shoulder 30 is provided with two openings 32, which are aligned with extensions 31 and are suitable for passage of lead portion 25 of slip ring 11′ associated with this shoulder 30 into the inside of spacer ring 21′. Adjacent to each opening 32 is a pocket 34 disposed on radial inside 33 of spacer ring 21′, which pocket has the form of a slot-like depression 35 that is suitable for receiving lead portion 25 of slip ring 11′ routed through radially below slip ring 10′.

In all other respects, the foregoing explanations of FIGS. 1 and 2 are applicable for the slip ring element illustrated in FIGS. 3 and 4, and so the corresponding descriptions are referred to in order to avoid repetitions.

1. An electric machine with a stator (1, 1′) and a rotor (2), which is mounted in two bearings (3, 3′) to rotate around its longitudinal axis (4, 4′) and is provided with a rotor winding (5, 5′), wherein there is disposed on a rotor shaft journal (6, 6′) protruding beyond one of the bearings (3, 3′) a slip ring element (7, 7′), which comprises a support member (8, 8′), injection-molded from insulating material and having a bore (9, 9′) for the rotor shaft journal, and two slip rings (10, 10′; 11, 11′), which are provided with leads (12, 12′; 13, 13′) jutting out of the support member of the slip ring element at the end face thereof proximal to the bearing and are connected to the rotor winding (5, 5′),
characterized in that
there is embedded, in the support member, a prefabricated spacer ring (21, 21′) of stepped structure, which bridges over the axial gap (22, 22′) between each pair of mutually adjacent slip rings and extends at least partly into the radial gap (23, 23′) between the one slip ring (10, 10′) and the lead (13, 13′) of the other slip ring (11, 11′).

2. An electric machine according to claim 1,
characterized in that
the support member (8, 8′) and the spacer ring (21, 21′) of the slip ring element (7, 7′) are composed of the same material.

3. An electric machine according to claim 1,
characterized in that
the radial gap (23′) between the one slip ring (10′) and the lead (13′) of the other slip ring (11′) is filled with the spacer ring (21′) to a proportion of at least 60% of the axial height of the slip ring in question.

4. An electric machine according to claim 1,
characterized in that
the spacer ring (21, 21′) of the slip ring element (7, 7′) is provided with a middle part (28) and two bushing-like shoulders (29, 30) of reduced diameter, the two slip rings (10, 10′; 11, 11′) resting on the outside of the bushing-like shoulders.

5. An electric machine according to claim 4,
characterized in that
the particular bushing-like shoulder (29) that extends at least partly into the radial gap (23, 23′) between the one slip ring (10, 10′) and the lead (13, 13′) of the other slip ring (11, 11′) is provided with an axial extension (31) in the region of the lead in question.

6. An electric machine according to claim 4,
characterized in that
the particular bushing-like shoulder (30) that does not extend into the radial gap (23, 23′) between the one slip ring (10, 10′) and the lead (13, 13′) of the other slip ring (11, 11′) is provided with a opening (32) for the lead (13, 13′) of the slip ring (11, 11′) associated with this shoulder.

7. An electric machine according to claim 1,
characterized in that
the spacer ring (21, 21′) of the slip ring element is provided on its radial inside (33) with a pocket (34) for receiving the lead (13, 13′), routed through radially below one slip ring (10, 10′), of the adjacent slip ring (11, 11′).

8. An electric machine according to claim 1,
characterized in that
the slip ring element comprising two slip rings (10, 10′; 11, 11′) is provided with a spacer ring (21, 21′) of axially symmetric construction.

9. An electric machine according to claim 8,
characterized in that
the support member (8) of the slip ring element (7) is provided at its end face (14) proximal to the bearing, in the region of the leads (12, 13), with depressions (16) that are suitable for receiving the outermost ends (17) of the conductors (18) of the rotor winding (5).

10. An electric machine according to claim 8,
characterized in that
end regions of the rotor winding (5) that have been stripped of insulation can be mechanically clamped in the ends (15) of the leads (12, 13) of the slip rings (10, 11).

11. An electric machine according to claim 1,
characterized in that
there is molded, onto the support member (8′) of the slip ring element (7′), insulating ribs, which are routed through below the adjacent rotor bearing (3′), wherein lead extensions (26, 27), which are received in the insulating ribs, are each connected at some distance from the slip rings (10′, 11′) to lead portions (24, 25) manufactured in one piece with the slip rings.

12. An electric machine according to claim 11,
characterized in that
the lead extensions (26, 27) are fused together with the associated lead portions (24, 25) by means of ultrasound.

13. An electric machine according to claim 11,
characterized in that,
with the exception of terminal lugs at their ends, the lead extensions (26, 27) are completely embedded in the insulating ribs.

14. A slip ring element (7, 7′) for an electric machine comprising a stator (1, 1′) and a rotor (2), whose rotor is provided with a rotor winding (5, 5′) and is mounted in two bearings (3, 3′) to rotate around its longitudinal axis (4, 4′), wherein the slip ring element comprises a support member (8, 8′), injection-molded from insulating material and having a bore (9, 9′) for the rotor shaft, and at least two slip rings (10, 10′; 11, 11′), which are provided with leads (12, 12′; 13, 13′) that jut out of the support member of the slip ring element in the same direction and can be connected to the rotor winding (5, 5′), and wherein furthermore there is embedded, in the support member, at least one prefabricated spacer ring (21, 21′) of stepped structure, which bridges over the axial gap (22, 22′) between each pair of mutually adjacent slip rings,
characterized in that
the spacer ring (21, 21′) extends at least partly into the radial gap (23, 23′) between one slip ring (10, 10′) and the lead (13, 13′) of the adjacent slip ring (11, 11′).
